(19) United States
(12) Patent Application Publication
(10) Pub. No.: US 2002/0020104 A1
(43) Pub. Date: Feb. 21, 2002

(54) Insulated bait container

(76) Inventors: Martin Kolar, Thunder Bay (CA); Brian Cole, Thunder Bay (CA)

Correspondence Address: ADE & COMPANY, 1700-360 MAIN STREET, WINNIPEG, MB, R3C3Z3, CA

(21) Appl. No.: 09/870,694

(22) Filed: Jun. 1, 2001

(30) Foreign Application Priority Data
Aug. 21, 2000 (CA) 2,316,561

(51) Int. Cl. A01K 97/00; A01K 97/04

(52) U.S. Cl. 43/55

(57) ABSTRACT

A method and container is provided for storing live bait in an ice fishing hole. The container includes a perforated bucket arranged to be supported in the ice fishing hole for receiving the live bait therein. An outer bucket is provided for supporting the perforated bucket therein for transport of the bait. An insulated cover is arranged to extend across an open top end of the perforated bucket and the ice fishing hole to prevent the ice fishing hole from freezing over. The cover includes a hanger coupling the perforated bucket thereto such that the perforated bucket is suspended from the cover when the cover is pulled from either the outer bucket or the ice fishing hole.

### FIELD OF THE INVENTION

The present invention relates to an insulated bait container and more particularly to a bait container for use when ice fishing.

### BACKGROUND

When fishing with live bait, the use of an insulated bait container is known for storing bait therein. The insulated container protects the bait therein from heat in the warmer seasons and from cold in the colder seasons. Known insulated bait containers however are not adapted for use in extreme cold such as when ice fishing nor are they able to provide fresh water to the bait therein in such weather. The loss of live bait due to the cold temperature and to stale water is thus known to occur.

U.S. Pat. No. 5,109,625 to Skrede provides a bait bucket having an insulated outer shell and a perforated liner arranged to be received therein. The liner includes a cover which is too thin to be sufficiently insulated causing sufficient heat loss to result in frozen bait if used in the cold temperatures of ice fishing. Furthermore, the cover is a small panel which must be pivoted upwardly to be opened. To open the cover there is provided a complex linkage which can also be subject to freezing such that the cover remains frozen shut and inoperable in cold weather.

### SUMMARY

According to one aspect of the present invention there is provided a bait container for storing bait in a standard size ice fishing hole, the bait container comprising:

a perforated bucket having a bottom and sides extending upwardly therefrom to an open top end of the perforated bucket, the perforated bucket being suitably sized so as to be received within the ice fishing hole;

a support member extending laterally outward from the perforated bucket, the support member being arranged to engage a periphery of the ice fishing hole when the perforated bucket is received therein for supporting the perforated bucket within the ice fishing hole; and

a cover formed of insulated material and being arranged to enclose the ice fishing hole when the perforated bucket is supported in the ice fishing hole.

The perforated bucket allows water from the body of water over which the ice fishing hole is located, to be communicated through the bucket to insure that the live bait therein is continuously supplied with fresh water. Furthermore the insulated cover permits the perforated bucket to be supported in an ice fishing hole without the hole freezing over.

There may be provided an outer bucket having an insulated pottom and insulated sides extending upwardly therefrom to an open top side of the outer bucket so as to contain fluid therein, the outer bucket being arranged to receive the perforated bucket therein.

The outer bucket preferably includes a shoulder around an inner surface thereof adjacent the top end of the outer bucket, the shoulder being arranged to suspend the perforated bucket therefrom with the cover recessed within the bucket and supported thereon.

The support member may comprise an annular flange extending radially outward from the top end of the perforated bucket, the annular flange being arranged to engage a full circumference of the ice fishing hole.

The perforated bucket is preferably circular in cross section, having a diameter which is less than a diameter of the ice fishing hole so as to be spaced inwardly from periphery of ice fishing hole when received therein.

The perforated bucket may be formed of plastic material.

A hanger may be coupled between the cover and the perforated bucket, the hanger being arranged to suspend the perforated bucket therefrom when the cover positioned spaced above the perforated bucket.

According to a second aspect of the present invention there is provided a bait container comprising:

an outer bucket having a bottom and sides extending upwardly therefrom to an open top end of the outer bucket such that the outer bucket is arranged to contain a fluid therein;

a perforated bucket having a bottom and sides extending upwardly therefrom to an open top end of the perforated bucket, the perforated bucket being arranged to be received within the outer bucket;

a cover arranged to enclose the open top end of the outer bucket in a closed position when the perforated bucket is received in the outer bucket; and

a hanger coupled between the cover and the perforated bucket, the hanger being movable with the cover between the closed position and an open position in which the cover is spaced above the perforated bucket and the hanger is supported under tension with the perforated bucket suspended therefrom.

The use of a hanger coupled between the perforated bucket and the cover provides a simple mechanism for lifting the cover and pulling the perforated bucket out of the cold water of an ice fishing hole in a single handed operation, thus leaving a person's other hand free to reach into the perforated bucket which is drained of water to retrieve bait therefrom.

The hanger preferably comprises a pair of links, each being coupled between the cover and the perforated bucket and spaced apart locations thereon.

Each link may be slidably mounted on the perforated bucket for movement relative to the perforated bucket with the cover between the respective open and closed positions thereof.

There may further be provided a stop member mounted on a bottom end of each link, the stop member having a curved top edge supporting the perforated bucket thereon in the open position so as to support the perforated bucket thereon for relative pivotal movement therebetween.

The hanger is preferably mounted for generally pivotal relative motion on the perforated bucket such that the cover may be pivoted laterally away from the perforated bucket in the open position.

Preferably there is provided a space between the perforated bucket and the outer bucket in the closed position so as to accommodate the links therebetween.

According to a further aspect of the present invention there is provided a method of storing bait in an ice fishing hole, the method comprising:

providing a perforated bucket having a bottom and sides extending upwardly therefrom to an open top end of the perforated bucket;

suspending the perforated bucket in the ice fishing hole;

placing bait in the perforated bucket;

providing an insulated cover; and

placing the insulated cover across the ice fishing hole so as to enclose the ice fishing hole.

The method of storing bait in an ice fishing hole instead of an insulated bucket when ice fishing insures that the bait is continuously fed with fresh water for preserving live bait therein. The use of an insulated cover permits a perforated bucket to be submerged in the ice fishing hole without the hole freezing over.

The perforated bucket may be formed of plastic material.

The perforated bucket is preferably circular in cross section and smaller in diameter than the ice fishing hole so as to be spaced inwardly from periphery of the ice fishing hole.

There may be provided an annular flange extending radially outward from a top end of the perforated bucket wherein the method includes placing the flange across a top side of the ice fishing hole so as to suspend the perforated bucket therefrom.

There may be provided a hanger arranged to suspend the perforated bucket from the cover when the cover is raised from the perforated bucket wherein the method comprises retrieving the bait by raising the cover until the perforated bucket is pulled by the hanger from the ice fishing hole.

The perforated bucket is preferably perforated on both the bottom and the sides thereof.

An outer bucket arranged to support the perforated bucket therein may be provided for transport.

### BRIEF DESCRIPTION OF THE DRAWINGS

In the accompanying drawings, which illustrate an exemplary embodiment of the present invention:

FIG. 1 is an isometric view of the bait container according to the present invention.

FIG. 2 is a sectional side elevational view of the perforated bucket of the bait container of FIG. 1 shown supported in an ice fishing hole.

FIG. 3 is a sectional side elevational view of the bait container of FIG. 1 in a closed position.

FIG. 4 is a top plan view of the bait container of FIG. 1.

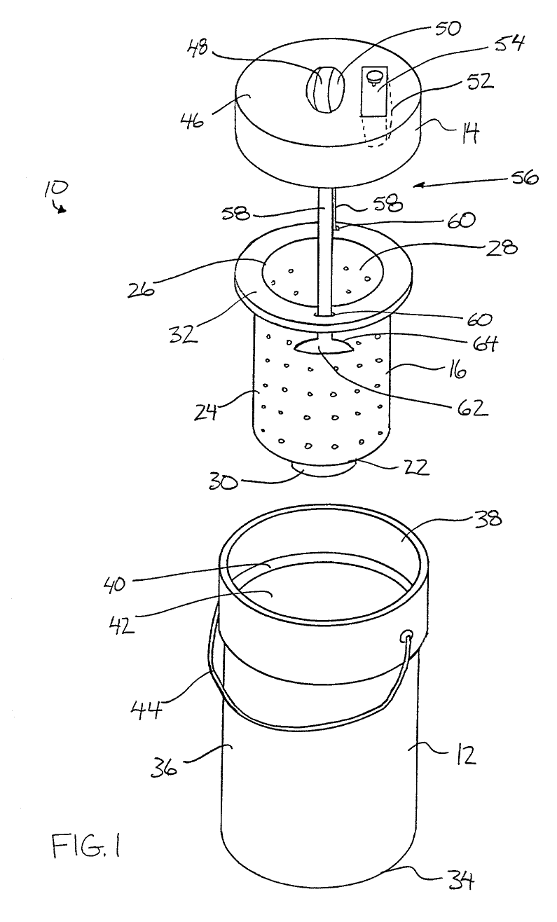

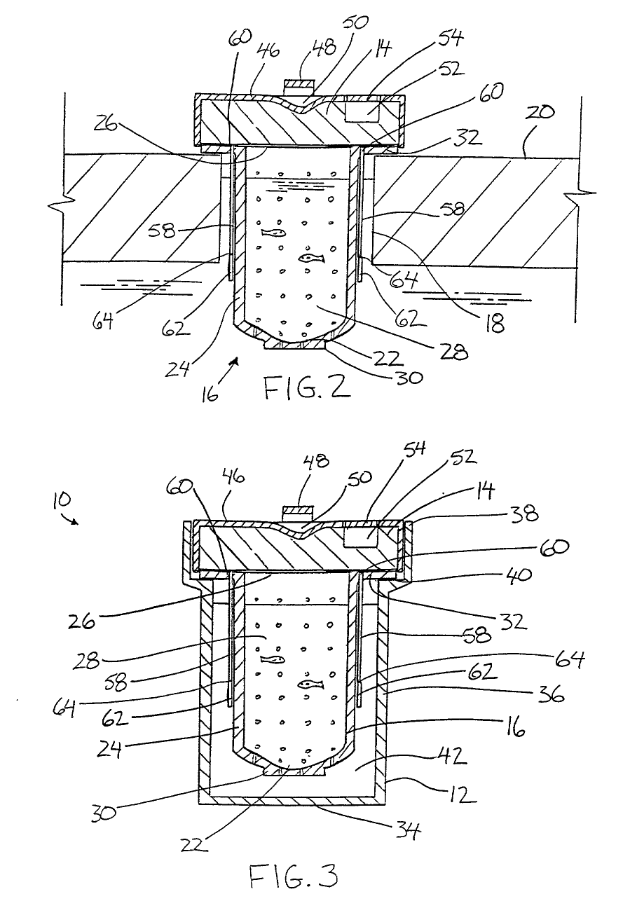

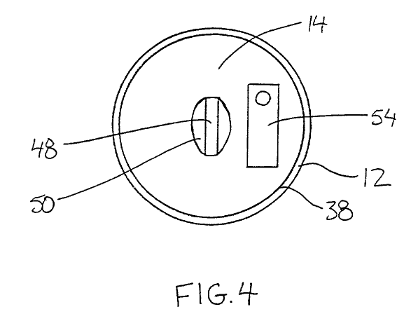

### DETAILED DESCRIPTION

Referring to the accompanying drawings, there is illustrated a bait container generally indicated by reference numeral 10. The container 10 is arranged for use in storing live bait therein, particularly when ice fishing, to insulate the bait from the cold and provide a method of supplying fresh water to the bait in such conditions. The container is also generally arranged for use in insulating the bait from excessive heat when used in warmer climates.

The container generally includes an outer bucket 12 and a cover 14 adapted therefor. A perforated bucket 16 is arranged to be supported within the outer bucket 12 as well as being arranged to be supported in an ice fishing hole 18 in a sheet of ice 20 which lies across an underlying body of water.

The perforated bucket 16 includes a bottom 22 and side walls 24 which extend upwardly therefrom to an open top end 26 of the bucket. The perforated bucket 16 is perforated on both the bottom 22 and the respective side walls 24 thereof. An inner surface 28 of the perforated bucket is generally concave along the bottom 22 so as to gather the bait towards the center of the perforated bucket when the bucket is drained of water. An annular rib 30 is formed on an outer side of the bottom 22 of the perforated bucket such that the bucket can be supported generally upright on a flat surface.

The perforated bucket 22 is generally circular in cross section being slightly less in diameter that the diameter of a standard ice fishing hole 18 so as to be suitably sized to be received therein. An annular flange 32 is mounted about the open top end 26 of the perforated bucket to extend radially and laterally outward therefrom. The annular flange 32 is bigger in dimension then the standard ice fishing hole 18 such that the flange is able to engage a full circumference of the ice fishing hole when the perforated bucket is received therein for supporting the bucket in the ice fishing hole. The perforated bucket is formed of a plastic material.

The outer bucket 12 is generally circular in cross section and suitably sized to support the perforated bucket 16 therein. The outer bucket includes a bottom 34 and respective side walls 36 extending upwardly therefrom to an open top end 38 of the outer bucket.

The outer bucket 12 includes a shoulder 40 located around an inner side 42 of the bucket adjacent but spaced below the open top end 38 thereof. The annular flange 32 of the perforated bucket 16 is greater in diameter than the shoulder 40 so as to be supported thereon recessed from the open top end of the outer bucket. The outer bucket is thus arranged to contain water therein while suspending the perforated bucket therein from the shoulder 40.

The outer bucket 12 is formed of a plastic shell lined with an insulating foam material. A handle 44 is further provided of the outer side of the outer bucket to support the outer bucket independently of the perforated bucket therein.

The cover 14 is generally circular in shape and sized to fit within the open top end 26 of the outer bucket while being sufficient in diameter to be supported on the shoulder 40 of the bucket. The cover is bigger in diameter than the annular flange 32 of the perforated bucket as well as being greater in diameter than a standard ice fishing hole 18. The cover generally comprises an outer shell 46 which is lined with insulating foam material. A handle 48 is located on a top side thereof above a recessed portion 50 of the cover to provide access for easily gripping the handle 48.

A storage compartment 52 is recessed into a top side of the cover and includes an access panel 54 pivotally mounted in a top side thereof with its own respective handle for enclosing the storage compartment 52 in the top side of the cover.

A hanger 56 is provided for coupling the cover 14 to the perforated bucket 16. The hanger 56 is arranged to be supported under tension below the cover 14 with the perforated bucket 16 suspended therefrom spaced below the cover for removing the cover and lifting the perforated bucket 16 from the outer bucket 12 in a single handed operation by grasping handle 48 and pulling upwardly.

The hanger 56 generally comprises a pair of links 58 which are pivotally mounted on the bottom side of the cover 14 on respective brackets at spaced and diametrically opposed positions thereon, aligned with the annular flange 32 of the perforated bucket there below.

A pair of slots 60 are located in the annular flange 32 at diametrically opposed positions in alignment with the respective links 58 for slidably mounting the respective lengths 58 therethrough. Each slot 60 is wider than the corresponding link 58 extending therethrough to allow relative pivotal and lateral movement therebetween.

A stop member 62 is located on a bottom end of each link opposite a pivotal end mounted on the cover 14. The stop members 62 are considerably wider than the slots 60 such that the annular flange 32 is supported on the stop members and the perforated bucket is suspended therefrom with the links 58 under tension the stop members 62 are curved about the perforated bucket 16 so as to occupy minimal space and so as to be located within the space between the perforated and outer buckets when the perforated bucket is received within the outer bucket.

An outer diameter of the perforated bucket is slightly less in diameter than an inner diameter of the outer bucket so as to define the space therebetween for receiving the links 58 in a closed position,

A top edge 64 of each stop member 62 is generally convex to permit the cover 14 to be pivoted laterally with the links 58 relative to the perforated bucket in an open position thereof when the perforated bucket is suspended spaced below the cover 14 by the hanger 56. The contact area of the annular flange 32 which is supported on the stop members 62 is slidably displaced along the top edge 64 of the stop members as the cover 14 is pivoted to provide greater clearance for a person who wishes to reach into the perforated bucket to retrieve bait.

In use the outer bucket 12 is first filled with water and the perforated bucket 16 is then received therein. Bait is contained within the perforated bucket 16 which the water in the outer bucket is free to flow through the perforations in the perforated bucket to communicate fresh water to the bait.

The cover 14 is recessed into the open top end of the bucket for enclosing both the open top ends of the outer bucket 12 and the perforated bucket 16. The arrangement of the cover 14 over the outer bucket 12 provides an insulated bait container which is insulated from both excessive heat and cold while being easily transportable.

In order to retrieve bait from the bait container 10, an individual first lifts the cover 14 upwardly to slide the links 58 through the respective slots 60 in the flange 32 of the perforated bucket up to a fully extended position of the links when the links are supported in tension and the flange 32 is supported on the stop members 62.

Continued lifting of the cover 14 will lifted the perforated bucket out of the water in the outer bucket permitting the water to be drained out of the perforated bucket such that the bait is gathered in the concave bottom 22 of the perforated bucket.

For further access to the bait the person may pivot the cover laterally in relation to the perforated bucket and then reach in to grab the bait which has been drained out of the water. The perforated bucket is subsequently returned back into the outer bucket.

In order to maintain live bait fresh when ice fishing a standard ice fishing hole 18 having a standard diameter is formed so that the perforated bucket may be lifted from the outer bucket using the cover 14 and then inserted into the standard ice fishing hole. By resting the annular flange 32 on a top side of the ice fishing hole about a periphery thereof the perforated bucket is suspended in the ice fishing hole. The cover 14 may then be lowered over the perforated bucket with the links 58 being permitted to slide between the perforated bucket and the periphery of the hole until the cover encloses both the perforated bucket and the ice fishing hole.

Fresh water from the underlying body of water is thus free to flow through the perforations in both the bottom and sides of the perforated bucket while the cover 14 prevents the hole from freezing over. Bait is retrieved from the ice fishing hole by lifting the cover 14 similarly as described above to retrieve bait from the outer bucket in a single handed operation without the need to submerge a hand into cold water containing the bait therein.

While one embodiment of the present invention has been described in the foregoing, it is to be understood that other embodiments are possible within the scope of the invention. The invention is to be considered limited solely by the scope of the appended claims.

1. A bait container for storing bait in a standard size ice fishing hole, the bait container comprising:
a perforated bucket having a bottom and sides extending upwardly therefrom to an open top end of the perforated bucket, the perforated bucket being suitably sized so as to be received within the ice fishing hole;
a support member extending laterally outward from the perforated bucket, the support member being arranged to engage a periphery of the ice fishing hole when the perforated bucket is received therein for supporting the perforated bucket within the ice fishing hole; and
a cover formed of insulated material and being arranged to enclose the ice fishing hole when the perforated bucket is supported in the ice fishing hole.

2. The container according to claim 1 wherein there is provided an outer bucket having an insulated bottom and insulated sides extending upwardly therefrom to an open top side of the outer bucket so as to contain fluid therein, the outer bucket being arranged to receive the perforated bucket therein.

3. The container according to claim 2 wherein the outer bucket includes a shoulder around an inner surface thereof adjacent the top end of the outer bucket, the shoulder being arranged to suspend the perforated bucket therefrom with the cover recessed within the bucket and supported thereon.

4. The container according to claim 1 wherein the support member comprises an annular flange extending radially outward from the top end of the perforated bucket, the annular flange being arranged to engage a full circumference of the ice fishing hole.

5. The container according to claim 1 wherein the perforated bucket is circular in cross section, having a diameter which is less than a diameter of the ice fishing hole so as to be spaced inwardly from periphery of ice fishing hole when received therein.

6. The container according to claim 1 wherein the perforated bucket is formed of plastic material.

7. The container according to claim 1 wherein there is provided a hanger coupled between the cover and the perforated bucket, the hanger being arranged to suspend the perforated bucket therefrom when the cover positioned spaced above the perforated bucket.

8. A bait container comprising:
an outer bucket having a bottom and sides extending upwardly therefrom to an open top end of the outer bucket such that the outer bucket is arranged to contain a fluid therein;
a perforated bucket having a bottom and sides extending upwardly therefrom to an open top end of the perforated bucket, the perforated bucket being arranged to be received within the outer bucket;
a cover arranged to enclose the open top end of the outer bucket in a closed position when the perforated bucket is received in the outer bucket; and
a hanger coupled between the cover and the perforated bucket, the hanger being movable with the cover between the closed position and an open position in which the cover is spaced above the perforated bucket and the hanger is supported under tension with the perforated bucket suspended therefrom.

9. The bait container according to claim 8 wherein the hanger comprises a pair of links, each being coupled between the cover and the perforated bucket and spaced apart locations thereon.

10. The bait container according to claim 9 wherein each link is slidably mounted on the perforated bucket for movement relative to the perforated bucket with the cover between the respective open and closed positions thereof.

11. The bait container according to claim 10 wherein there is provided a stop member mounted on a bottom end of each link, the stop member having a curved top edge supporting the perforated bucket thereon in the open position so as to support the perforated bucket thereon for relative pivotal movement therebetween.

12. The bait container according to claim 8 wherein the hanger is mounted for generally pivotal relative motion on the perforated bucket such that the cover may be pivoted laterally away from the perforated bucket in the open position.

13. The bait container according to claim 9 wherein there is provided a space between the perforated bucket and the outer bucket in the closed position so as to accommodate the links therebetween.

14. A method of storing bait in an ice fishing hole, the method comprising:
providing a perforated bucket having a bottom and sides extending upwardly therefrom to an open top end of the perforated bucket;
suspending the perforated bucket in the ice fishing hole;
placing bait in the perforated bucket;
providing an insulated cover; and
placing the insulated cover across the ice fishing hole so as to enclose the ice fishing hole.

15. The method according to claim 14 wherein the perforated bucket is formed of plastic material.

16. The method according to claim 14 wherein the perforated bucket is circular in cross section and smaller in diameter than the ice fishing hole so as to be spaced inwardly from periphery of the ice fishing hole.

17. The method according to claim 14 wherein there is provided an annular flange extending radially outward from a top end of the perforated bucket and wherein the method includes placing the flange across a top side of the ice fishing hole so as to suspend the perforated bucket therefrom.

18. The method according to claim 14 wherein there is provided a hanger arranged to suspend the perforated bucket from the cover when the cover is raised from the perforated bucket wherein the method comprises retrieving the bait by raising the cover until the perforated bucket is pulled by the hanger from the ice fishing hole.

19. The method according to claim 14 wherein the perforated bucket is perforated on both the bottom and the sides thereof.

20. The method according to claim 14 including providing an outer bucket arranged to support the perforated bucket therein for transport.
